(19) United States
(12) Patent Application Publication
(10) Pub. No.: US 2010/0052220 A1
(43) Pub. Date: Mar. 4, 2010

(54) Ceramic Product Made with Glass and High Alumina Cement and Method of Manufacturing Same

(76) Inventors: Paul Burns, San Francisco, CA (US); Robert J. Kirby, Seattle, WA (US)

Correspondence Address: GORDON & REES LLP, 101 WEST BROADWAY, SUITE 1600, SAN DIEGO, CA, 92101, US

(21) Appl. No.: 12/390,933

(22) Filed: Feb. 23, 2009

Related U.S. Application Data
(60) Provisional application No. 61/190,817, filed on Sep. 3, 2008.

(51) Int. Cl. B28B 3/00; C03C 14/00

(52) U.S. Cl. 264/333; 501/32

(57) ABSTRACT

A composition of matter incorporating waste glass into a ceramic and cement composite material, comprising: 70 to 95 percent by weight glass; 5 to 35 percent by weight high alumina cement; 0 to 20 percent by weight inert filler; and 0 to 5 percent by weight additives.

### RELATED APPLICATION

The present application claims priority to U.S. Provisional Patent Application Ser. No. 61/190,817, entitled “Ceramic Product Made With Glass And High Alumina Cement And Method Of Manufacturing Same”, filed Feb. 26, 2008.

### TECHNICAL FIELD

The present invention relates generally to building materials including ceramics and cements, and in particular to environmentally-friendly low carbon footprint building materials that can be produced with reduced carbon emissions.

### BACKGROUND OF THE INVENTION

Of the 11 million tons of container glass used by consumers, over three million tons were collected by recycling programs in the United States in 2007. Much of the collected glass was used in the manufacture of new containers. Unfortunately, recycled glass has low value and the costs of shipping it are high. As a result of the poor economics, millions of tons of waste glass are either not collected or are not used to manufacture new containers. New uses are needed to improve markets for recycled glass.

Over the years, a number of processes have been developed using glass as a raw material in the manufacture of ceramic products. However, none of these processes have proven to be practical. Some of these processes require the use of heat-resistant molds or other difficult or expensive manufacturing systems. Other processes use organic binders that burn off during firing. When this happens, they lack strength to hold their shape during firing. As such, any large item formed this way requires a heat-resistant mold. Unfortunately, such molds represent a substantial thermal mass in the kiln and absorb a substantial amount of energy. Mechanical presses could be used to improve the material strength of the resulting ceramic, but this adds expensive and impractical complexity to the process. Other ceramic approaches use binders that shrink, leading to cracking. Moreover, pieces formed with binders also have the tendency to seal over during firing, trapping bubbles of volatile gasses therein. A possible solution is to fire slowly, and prevent large temperature differences between the top and bottom of the piece being formed—but this wastes time and energy.

Processes also exist for using glass with portland cement as a binder to make concrete items containing recycled glass. A disadvantage to the environment is the large amount of carbon emissions that occur when making portland cement. Product disadvantages include lower flexure strength (as compared to ceramics) resulting in heavier and thicker pieces and the inability to achieve the full density and glazed, sterile, impervious, shiny surfaces that ceramic products can possess.

What is desired is a system that combines the best aspects of ceramic and cement manufacturing in a material made with reduced carbon emissions.

### SUMMARY OF THE INVENTION

The present invention incorporates waste glass with the best aspects of ceramic and cement manufacturing to produce a novel material that is ideally suited for use in green building design, construction, and retrofit operations. The present invention combines the best features of ceramics and cements, including easy workability, air curing, fast firing, energy savings, and carbon emission reductions to provide a high density building material.

In one aspect, the present invention uses post-consumer waste glass to convert the lowest value recycled glass into products that can substitute for ceramic tile and mined granite. The present material is fire-proof, stain resistant, and very durable.

In one preferred aspect, the present invention provides a composition of matter, comprising: 70 to 95 percent by weight glass; 5 to 35 percent by weight high alumina cement, 0 to 20 percent by weight inert filler; and 0 to 5 percent by weight additives.

In another preferred aspect, the present invention provides a method of manufacturing a composition of matter, comprising: (a) preparing a dry composition of matter comprising: 70 to 95 percent by weight glass; 5 to 35 percent by weight high alumina cement; 0 to 20 percent by weight inert filler; and 0 to 5 percent by weight additives; (b) mixing the dry composition of matter with water to form a mixture; (c) pouring the mixture into a mold; (d) curing the mixture in the mold to form a cured piece; (e) removing the cured piece from the mold; and (f) firing the cured piece to final density.

One particular advantage of the present material is that it is manufactured in a manner that produces far less carbon emissions than is typical with cement-based building materials. Other advantages of the present material include, but are not limited to:
(a) air curing with no external heat needed;
(b) low shrinkage during curing and firing, which reduces cracking;
(c) high strength;
(d) near zero porosity;
(e) moderately contaminated glass may be used, yet still not detract from the aesthetics of the finished product; and
(f) the 70% coarse (8 U.S. standard mesh and finer) glass particles of which it is comprised are a source of inexpensive raw material.

### DETAILED DESCRIPTION OF THE INVENTION

The present invention provides a composition of matter, comprising: 70 to 95 percent by weight glass; 5 to 35 percent by weight high alumina cement; 0 to 20 percent by weight inert filler; and 0 to 5 percent by weight additives. In preferred aspects, the 5 to 35 percent by weight high alumina cement is 5 to 25 percent by weight high alumina cement; the 0 to 20 percent by weight inert filler is 0 to 10 percent by weight inert filler; and the 0 to 5 percent by weight additives is 0 to 2 percent by weight additives.

Preferably, the glass is crushed glass, has a graduation 8 U.S. standard mesh or finer, and is crushed recycled glass. The additives may optionally be selected from the group consisting of: surfactants, flocculants, deflocculants, coagulants, plasticizers, antifoaming agents, lubricants, water reducers, preservatives, and colorants. In addition, the inert filler is preferably neither glass nor cement.

The present invention also provides a method of manufacturing a composition of matter, comprising: (a) preparing a dry composition of matter comprising: 70 to 95 percent by weight glass; 5 to 35 percent by weight high alumina cement; 0 to 20 percent by weight inert filler; and 0 to 5 percent by weight additives; (b) mixing the dry composition of matter with water to form a mixture; (c) pouring the mixture into a mold; (d) curing the mixture in the mold to form a cured piece; (e) removing the cured piece from the mold; and (f) firing the cured piece.

Preferably, mixing the dry composition of matter with water to form a mixture comprises forming a thixotropic mixture; and firing the cured piece to a maximum temperature of 1,500 F to 1,900 F.

The present invention uses calcium aluminate cement (also called “high alumina cement” or fondue cement). High alumina cement has the advantage of releasing far less calcium oxide when heated (and at a much higher temperature) than traditional portland cement. Too much free calcium oxide present during firing blocks the fusing the glass, greatly weakening the final product. Furthermore, when portland cement is heated to high temperatures (above 800 F) and all of the chemical water is driven off, the calcium silicate bonds that hold it together can fail during firing, causing the piece to fall apart.

In accordance with the present invention, high alumina cement is used as an inorganic binder that holds glass particles together in a shape that is placed in a kiln or furnace. The glass particles soften and fuse (at 1250 F to 1850 F) while the calcium aluminate cement holds the object shape while the glass particles coalesce (due to surface tension) to provide final strength and full density upon cooling. After cooling, the calcium aluminate cement becomes, in essence, an inert filler surrounded by a glassy matrix. During firing, the calcium aluminate cement maintains sufficient strength (such that preferably no mold is needed). Advantageously, the calcium aluminate cement also has a high thermal shock resistance such that a cured object can rapidly be moved from room temperature into a kiln. This facilitates firing on a belt furnace where the piece is carried through zones of heating and cooling. In addition, the calcium aluminate cement holds the particles apart until the highest temperature is reached (i.e.: retains porosity during firing), thereby allowing any volatiles and free water to escape during firing.

Preferably, there is a range of particle sizes in the mix such that efficient packing of fine and coarse particles minimizes the amount of cement needed to attain the initial air curing of the cement with sufficient strength to handle and fire the piece. Specifically, in order for the cement to function as a binder, it needs to contact all the other materials. Effective particle packing both minimizes the amount of water required and generates more intimate contact between the cement and the other materials by eliminating voids. Minimizing the amount of water through optimal particle packing also reduces the ultimate shrinkage. When the composition with the least percentage of void space is found, that can become the standard mix for the composition.

In one preferred aspect, 8 U.S. standard mesh glass is used. Next, 5 to 50% calcium aluminate cement is then mixed with the glass. Then a source of fine material (which can optionally be finely crushed glass or fine inert filler) is added to the glass and calcium aluminate cement mixture. A particle packing test may then be performed to determine the percentage of void space in the mixture. In further aspects, an inert filler may optionally be added to the formulation to improve the initial particle packing, stabilize dimensionality during firing, and possibly add texture or color to the final product.

Water (or water with additives such as reducers and plasticizers) can then be added to the standard mix, until a workable castable mixture is developed. After being placed in a mold, standard techniques such as vibration and trowling can be used to evenly spread the material in the mold. Three dimensional objects can be formed by casting the mixture into multiple-piece molds. Because the mixture cures rather than dries, the mixture hardens and cures without the need for drying in the open air.

The mold can be made of any material that holds the mixture during curing (e.g.: wood, plaster or plastic). After leveling, the mold containing the mixture can be set aside to cure. Typical curing time at room temperature can be 24 to 48 hours. Curing can also be performed with heat drying assist (which can shorten curing time to a few hours).

After curing, the product can be removed from the mold. The product can then be placed into a batch or continuous kiln and fired. Preferably, if a mold support is not used, the kiln heat can penetrate the piece from all sides, accelerating the firing. Also, volatiles can exit quicker and much less heat is required.

The cured piece can be fired immediately, or first held at an intermediate temperature for a moderate period of time (for example: 30 minutes at less than 1500 F) so that all the chemical water can be driven off. Afterwards, the piece temperature can be raised to between 1500 F and 1900 F (for example: for 30 minutes). After holding the piece at maximum temperature, the piece can immediately be placed in an annealing zone for a moderate (example: 30 minute) time period. The piece can then be cooled to ambient temperatures (often in about 60 minutes). Still air can optionally be used during this cooling time for uniform cooling.

The strength of the calcium aluminate cement has the advantage of holding the piece together as maximum temperature heat penetrates the piece. This strength also enable trapped volatiles to escape during firing. In contrast, clay or organic binders have much lower strength during at similar temperatures. Also, clay or organic binders do not develop enough cured strength to fire the large (48-inch square 200 pound) monolithic pieces possible using this process.

Using the above described process, the present inventions have fabricated 48-inch square monolithic fired ceramic pieces with absorption of less than 2 percent in 2 ½ hours. This is an immense improvement over traditional conventional ceramic materials and techniques.

If aesthetics and the impervious surface typical of glazed ceramics is preferred, then the piece can be coated with a glaze before firing. Alternatively, the upper surface of the piece can be coated with a flux that will melt over the piece, causing an integral glazed surface to form on the piece.

What is claimed is:

1. A composition of matter, comprising:
70 to 95 percent by weight glass;
5 to 35 percent by weight high alumina cement;
0 to 20 percent by weight inert filler; and
0 to 5 percent by weight additives.

2. The composition of matter of claim 1, wherein the 5 to 35 percent by weight high alumina cement is 5 to 25% by weight high alumina cement.

3. The composition of matter of claim 1, wherein the 0 to 20 percent by weight inert filler is 0 to 10 percent by weight inert filler.

4. The composition of matter of claim 1, wherein the 0 to 5 percent by weight additives is 0 to 2 percent by weight additives.

5. The composition of matter of claim 1, wherein the glass is crushed glass.

6. The composition of matter of claim 5, wherein the crushed glass is graduation 8 U.S. standard mesh and finer.

7. The composition of matter of claim 5, wherein the crushed glass is crushed recycled glass.

8. The composition of matter of claim 1, wherein the additives are selected from the group consisting of:
surfactants, flocculants, deflocculants, coagulants, plasticizers, antifoaming agents, lubricants, water reducers, preservatives, and colorants.

9. The composition of matter of claim 1, wherein the inert filler is neither glass nor cement.

10. A method of manufacturing a composition of matter, comprising:
preparing a dry composition of matter comprising:
70 to 95 percent by weight glass;
5 to 35 percent by weight high alumina cement;
0 to 20 percent by weight inert filler; and
0 to 5 percent by weight additives;
mixing the dry composition of matter with water to form a mixture;
pouring the mixture into a mold;
curing the mixture in the mold to form a cured piece;
removing the cured piece from the mold; and
firing the cured piece.

11. The method of claim 10, wherein mixing the dry composition of matter with water to form a mixture comprises forming a thixotrophic mixture.

12. The method of claim 10, wherein firing the cured piece comprises firing the cured piece to a maximum temperature of 1,500 F to 1,900 F.
